(19) United States
(12) Patent Application Publication
(10) Pub. No.: US 2009/0155017 A1
(43) Pub. Date: Jun. 18, 2009

(54) SECURE COMPOSITE FASTENER

(75) Inventor: Gary R. Wittman, Costa Mesa, CA (US)

Correspondence Address: KNOBBE MARTENS OLSON & BEAR LLP, 2040 MAIN STREET, FOURTEENTH FLOOR, IRVINE, CA, 92614, US

(73) Assignee: Tiodize Co., Inc., Huntington Beach, CA (US)

(21) Appl. No.: 12/272,691

(22) Filed: Nov. 17, 2008

Related U.S. Application Data
(60) Provisional application No. 60/988,748, filed on Nov. 16, 2007.

(51) Int. Cl. F16B 33/02; B29C 45/14

(52) U.S. Cl. 411/366.3; 264/279; 264/279.1

(57) ABSTRACT

Disclosed are various embodiments of a secure composite fastener. In some embodiments, a threaded inner core is formed of a polymeric based composite and is surrounded by an outer portion formed of a different polymeric composite that has a high resistance to permanent mechanical deformation. The fastener can have a threaded bore located centrally and extending axially therethrough. The diameter of the threaded bore is reduced in the section of the bore that extends through the outer portion. The reduction in diameter can form a locking portion.

Also disclosed are a secure composite fastener system, a method of use of the secure composite fastener, and a method of manufacture of a secure composite fastener

### REFERENCE TO PRIOR APPLICATIONS

This application claims the benefit under 35 U.S.C. § 119(e) of U.S. Provisional Patent Application No. 60/988,748, entitled “Secure Composite Fastener,” filed on Nov. 16, 2007, which is hereby incorporated by reference in its entirety and made part of this specification.

### BACKGROUND

1. Field of the Disclosure

The present disclosure relates in general to the field of fasteners, such as nuts and bolts, and in particular to secure fasteners formed from fiber reinforced composite materials.

2. Description of the Related Art

Existing fasteners have various drawbacks relating to: lack of strength when stressed in some directions; excessive weight; tendency to come loose when subject to vibrations; etc. The structures, concepts, materials, methods, and other disclosure provided herein help mitigate and resolve these existing drawbacks.

### SUMMARY OF INVENTION

According to an aspect of the present disclosure there is provided a system for fastening. The system can include a receiving fastener comprising: an inner portion formed of a first polymeric composite material; an outer portion formed of a second polymeric composite material, the first polymeric composite material having a shear modulus that is greater than that of the second polymeric composite material, and the second polymeric composite material having an elastic modulus that is greater than that of the first polymeric composite material; and a threaded bore having an elongate axis that extends at least partially through both the first polymeric composite material of the inner portion and the second polymeric composite material of the outer portion, such that the bore has a first diameter through the inner portion and a second diameter through the outer portion, and the first diameter of bore is larger than the second diameter of the bore. In some embodiments, the inner portion of the receiving fastener extends only along a first partial length of the threaded bore and forms a sidewall of and immediately surrounds the threaded bore along that first partial length, the inner portion is arranged relatively inwardly of the outer portion with respect to the elongate axis of the threaded bore such that the inner portion is nested radially within the outer portion along the first partial length. In some embodiments, the outer portion of the receiving fastener extends the full length of the threaded bore but forms a sidewall of and immediately surrounds the threaded bore only long a second partial length of the threaded bore where the inner portion is not nested radially within the outer portion. The system for fastening can also include a threaded elongate receivable fastener configured to be received by the receiving fastener and threadedly engage and extend through first the first partial length of the threaded bore, where the inner portion forms the sidewall of the bore, and as the elongate fastener is further inserted into the fastener, threadedly engage and extend through the second partial length of the threaded bore, where the outer portion forms the sidewall of the bore, such that the threaded elongate receivable fastener is fastened to the receiving fastener. The system for fastening can be configured such that the inner portion provides strength along the elongate axis of the inner bore to inhibit the receivable fastener from stripping out the threads of the receiving fastener. The system for fastening may also be configured such that outer portion provides a gripping force that inhibits relative rotation between the receivable and receiving fasteners.

According to a further aspect of the present disclosure, there is provided an annular fastener comprising: an inner portion configured to engage an elongate fastener, the inner portion comprising a shear force resistant material; and an outer portion configured to engage both the inner portion and the elongate fastener, the outer portion comprising a material that is relatively more resilient than the shear force resistant material.

According to a further aspect of the present disclosure, there is provided a method for fastening comprising: inserting a threaded elongate fastener into a threaded annular fastener; engaging threads of the elongate fastener with a sheer-force resistant portion of the threads in the annular fastener; subsequently engaging threads of the elongate fastener with a resilient portion of the threads in the annular fastener; and reversibly deforming the resilient portion of the threads with the threads of the elongate fastener, causing the annular fastener to grip the elongate fastener.

According to a further aspect of the present disclosure, there is provided a secure fastener system comprising: a two-part annular fastener comprising an inner portion and an outer portion, the inner portion comprising a shear-force resistant material, the outer portion comprising a material that is more resilient than the material of the shear-force resistant material, the material of the outer portion configured to engage the material of the inner portion; and an elongate fastener.

According to a further aspect of the present disclosure, there is provided a method of fastening comprising: inserting a threaded elongate fastener into a threaded annular fastener; engaging threads of the elongate fastener with a sheer-force resistant portion of the threads in the annular fastener; subsequently engaging threads of the elongate fastener with a resilient portion of the threads in the annular fastener; and reversibly deforming the resilient portion of the threads with the threads of the elongate fastener, causing the annular fastener to grip the elongate fastener.

According to a further aspect of the present disclosure, there is provided a method of making a secure fastener comprising: forming a threaded annular shaped inner core comprising a polymeric composite material having a high tensile modulus and shear modulus; and surrounding the inner core with an outer portion including a threaded surface, the outer portion comprising a composite material being more resilient than the material of the inner core.

### BRIEF DESCRIPTION OF THE DRAWINGS

The following drawings and the associated descriptions are provided to illustrate embodiments of the present disclosure and do not limit the scope of the claims.

FIG. 1 is a perspective view of a secure composite fastener system constructed in accordance with the teachings of the disclosure.

FIG. 2 is an elevated perspective view of a composite fastener, according to some embodiments of the disclosure.

FIG. 3 is an elevated perspective view of a composite fastener, according to some embodiments of the disclosure.

FIG. 4A is a plan view of a composite fastener, according to some embodiments of the disclosure.

FIG. 4B is a side sectional view taken along line 4B-4B of FIG. 4A.

FIG. 5A is a partial sectional view of an elongate fastener engaged with the threads of a secure fastener.

FIG. 5B is an enlarged view of the region circled in FIG. 5A.

### DETAILED DESCRIPTION OF THE PREFERRED EMBODIMENTS

Although certain preferred embodiments and examples are disclosed below, inventive subject matter extends beyond the specifically disclosed embodiments to other alternative embodiments and/or uses of the invention, and to modifications and equivalents thereof. Thus, the scope of the inventions herein disclosed is not limited by any of the particular embodiments described below. For example, in any method or process disclosed herein, the acts or steps of the method or process may be performed in any suitable sequence and are not necessarily limited to any particular disclosed sequence. For purposes of contrasting various embodiments with the prior art, certain aspects and advantages of these embodiments are described. Not necessarily all such aspects or advantages are achieved by any particular embodiment. Thus, for example, various embodiments may be carried out in a manner that achieves or optimizes one advantage or group of advantages as taught herein without necessarily achieving other aspects or advantages as may also be taught or suggested herein. The systems and methods discussed herein can be used anywhere, including, for example, in laboratories, manufacturing facilities, airports, or aircraft repair facilities.

In many applications, polymeric composites are useful for replacing metals because of improved performance. Polymeric composite materials are useful, for example, in applications where weight is a concern, such as the aviation industry. Composites are useful, for example, due to their high strength and stiffness-to-density ratio. On an equivalent weight basis, reinforced composite materials generally are both stronger and stiffer than aluminum or steel. Thus, utilization of composite materials in the design of the structural components of an aircraft can result in significant weight savings.

Other advantages of polymeric composite materials include their high resistance to corrosion, large operating temperature range, and vibration dampening ability. Also, many polymeric composites are electrically non-conductive, making them ideally suited for use as an insulator in electrically charged environments.

Along with replacing metals as the primary material of structural components, polymeric composite fasteners are also advantageous for replacing fasteners formed of metal. Due to their exceptional formability, fiber reinforced composites can be molded and machined with precision into complex shapes. Furthermore, because the physical properties of polymeric composites are generally anisotropic, composite fasteners can be specifically tailored to perform differently depending on the direction of an applied force. Embodiments disclosed herein provide examples of this feature.

When using a nut and bolt fastener, it is desirable, in some embodiments, to have a means to prevent loosening of the nut due to vibration, thermal expansion or other stresses. Typical fastener locking means such as lock washers and bolts with expanding shafts, however, may not be suitable for use with a structure formed from a composite material because they can cause cracking or other damage to the structure. Therefore there is a need for a composite fastener having a nut with a means to self-lock. This need is addressed by embodiments disclosed herein.

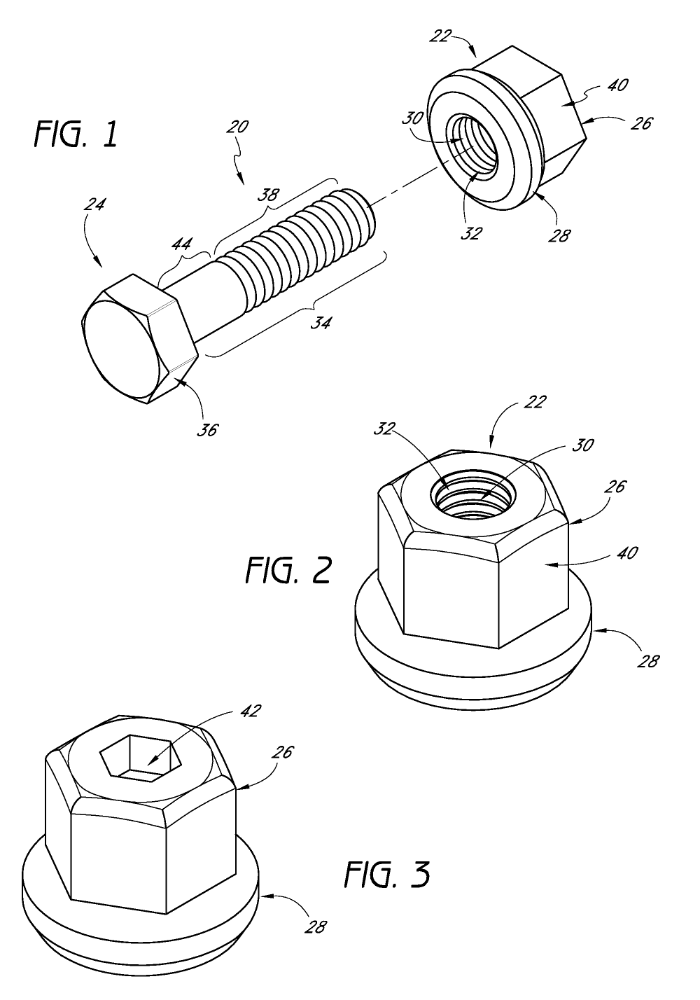

FIG. 1 generally illustrates an embodiment of a secure composite fastener system 20. The illustrated system 20 includes an elongate fastener 24 and a secure composite fastener 22. In some embodiments, as shown in FIG. 1, the elongate fastener 24 is a bolt. The bolt includes a shaft 34 having a generally cylindrical shape and a head portion 36. The shaft 34 includes a shank portion 44 and a threaded portion 38. The shank portion 44 and threaded portion 38 can be of any length. In some embodiments, the shaft 34 may not include a shank portion 44. The diameter of the threaded portion 38 is sized to correspondingly penetrate and threadedly engage the secure composite fastener 22. The head portion 36 of the elongate fastener 24 can have any shape, including hexagonal (see FIG. 1), square, circular, conical, etc. The head portion 36 may also include a recess located at the upper end for the engagement of a torque-providing tool. The recess may have any shape (including a simple slot or plus-sign shape for a regular screwdriver, square, hexagonal, 6-point star, 12-point star, etc.)

As shown in FIGS. 1, 2, and 4A, the secure fastener 22 may be configured as a nut having a head portion 26 and a base 28. The illustrated head portion 26 includes a wrenching surface such as a hexagonal shaped head 40 for engagement of a wrench, socket, pliers, or similar torque-providing tool. It will be appreciated by those of skill in the art that the head portion 26 may be configured as any shape (including, for example, square, circular, or generally circular with a ridged outer axial surface). In some embodiments of the secure fastener 22, as illustrated in FIG. 3, the head portion 26 may have a recessed wrenching feature 42 for the engagement of a hex key, screwdriver, or similar torque-providing tool.

The illustrated embodiment of the secure fastener 22 of FIG. 2 includes a cylindrically-shaped bore 30 located along the central-axis of the fastener 22 and extending therethrough. The fastener 22 has threads 32 disposed along the length of the bore 30. As used herein and disclosed in greater detail below, the term “bore” is a broad term and means, without limitation, an elongate opening having any shape, including but not limited to square, cylindrical, and conical. The bore 30 need not be of a constant diameter throughout the fastener 22. Furthermore, the threads 32 need not extend through the entire length of the fastener 22. The fastener 22 preferably has at least six threads. However, in some embodiments, the fastener 22 may have fewer than or more than six threads.

As illustrated in at least FIGS. 2 and 3, the head portion 26 may comprise a significant portion of the axial length of the fastener 22. In some embodiments, however, the length of the head portion 26 may represent a smaller portion or none of the total axial length of the fastener 22. These proportions can depend on the number and spacing of the threads 32. The fastener 22 may also be of a range of sizes, depending upon the particular application in which it is utilized. The fastener 22 can advantageously be sized in accordance with the metric and standard bolt sizes used in industry. Standardization can improve efficiency, for example. In some embodiments, however, the faster 22 is advantageously sized to be different from standard industry sizes in order to improve the likelihood that the item meets quality control standards and/or fits with a proprietary fastener system, etc. Non-standard sizing can improve control, for example. Examples of useful non-standard sizing that can be utilized include, but are not limited to, the sinusoidal and trapezoidal thread forms.

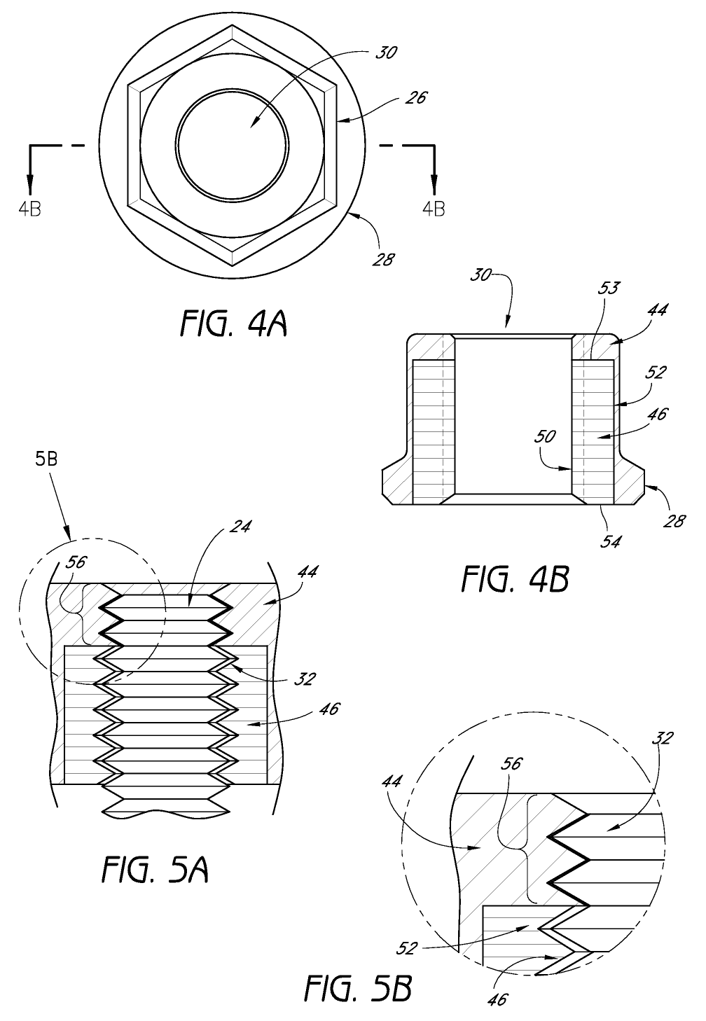

FIG. 4A shows a plan view of the fastener 22 shown in FIG. 2. FIG. 4B shows a cross section of the embodiment of FIG. 4A, taken along the line 4B-4B of FIG. 4A. FIG. 4B illustrates how, in some embodiments, the secure fastener 22 has an outer portion 44 and an annular shaped inner core 46 having a radially outer surface 52 and a radially inner surface 50. The outer portion 44 can at least partially surround and/or abut the radially outer surface 52 and an end of the inner core 46, as shown. In some advantageous embodiments, the outer portion surrounds and engages the top end 53 of the inner core 46 and forms the head portion 26 of the fastener. In some embodiments, however, the outer portion 44 may surround and engage both the top end 53 and the bottom end 54 of the inner core 46. The outer portion 44 and inner core 46 can be secured together in various ways. For example, the two portions can be chemically bonded together, molded together, radio-frequency or heat welded together, etc.

The threaded bore 30 of the fastener 22 extends axially through the outer portion 44 and the inner core 46 of the fastener, such that threads can be molded or cut into the radially inner surface 50. The bore 30 can be a constant or non-constant diameter throughout the length of the fastener 22. Advantageously, the diameter of the portion of the bore in the outer portion 44 can be slightly smaller than the diameter of the inner core 46. In such an embodiment, as illustrated in FIG. 5B, the diameter of the bore 30 slightly narrows at the top of the fastener 22 (see FIG. 5A and FIG. 5B).

The outer portion 44 and inner core 46 are formed, in some embodiments, of a polymeric composite material. The outer portion 44, however, need not be formed of the same material as the inner core 46. In some embodiments, the inner core 46 may be formed of a polymeric composite material exhibiting high tensile modulus and shear modulus and the outer portion of the fastener 44 may be formed of a polymeric composite that is more resilient to permanent mechanical deformation and has a higher elastic modulus than that of the material of the inner core 46. In some advantageous embodiments, the inner core 46 is formed of epoxy resin/chopped fiberglass (ECFG) and the outer portion 44 is formed of PEEK/milled fiberglass (PMFG).

Suitable composite materials for either the outer or inner portion include, but are not limited to, epoxy resin based composites with fiberglass, carbon fiber, carbon nanotube, carbon black, and graphitic carbon fillers, nylon resin based composites with fiberglass, carbon fiber, carbon nanotube, carbon black and graphitic carbon fillers, polycarbonate resin based composites with fiberglass, carbon fiber, carbon nanotube, carbon black, and graphitic carbon fillers, polyphenol sulfide (PPS) based composites with fiberglass, carbon fiber, carbon nanotube, carbon black, and graphitic carbon fillers, polyimide resins based composites with fiberglass, carbon fiber, carbon nanotube, carbon black, and graphitic carbon fillers, and polyetheretherketone resin (PEEK) based composites with fiberglass, carbon fiber, carbon nanotube, carbon black, and graphitic carbon fillers. Other resins and fillers can also be used to form a polymeric composite with both high tensile and high shear moduli. Metal can also be used to form one or both portions or the inner or outer portion. For the outer portion 44, it can be especially advantageous to design and/or select a polymeric composite having an elastic modulus that is higher than that of the composite forming the inner core 46, allowing the outer portion 44 to elastically deform more readily and secure the elongate fastener 24. A wide range of filler concentrations (e.g. volume percents), fiber diameters, and fiber lengths, and filler mixtures can be used.

FIG. 5A shows the elongate fastener 24 threadedly engaging the threaded bore 30. The diameter of the threaded portion of the inner core 46 is sized to correspondingly receive the threaded portion 38 of the elongate fastener 24. The reduced diameter of the outer portion 44 (compared to the diameter of the inner core 46) secures the elongate fastener 24. The reduced diameter portion can form a thread-locking area 56. Because the diameter of the threaded portion of the outer portion 44 is slightly smaller than that of the inner core 46, there is increased resistance to turning the fastener 22 as the threads of the thread-locking area 56 engage the threaded portion 38 of the elongate fastener 24. The threads of the thread-locking area 56 are resiliently deformed when engaging the elongate fastener 24. The thread deformation in the thread-locking area 56 increases the amount of force applied to the elongate fastener 24, which provides resistance to turning and prevents unwanted loosening of the fastener 22 due to vibration, shear and tensile forces, and thermal expansion.

In some embodiments, the bore 30 is of a constant diameter throughout the inner core 46 and outer portion 44. The threads of the thread-locking area 56, however, may be more tightly spaced together than the threads of the inner core 46. When the threads of the elongate fastener 24, which can be sized to correspondingly fit the threads of the inner core 46, engage the threads of the outer portion 44, the outer portion threads are resiliently deformed and exert an increased force on the elongate fastener 24. The increased force provides resistance to turning and unwanted decoupling of the fastening system 20.

In some embodiments, the threads of the thread-locking area 56 have a thread angle that is not the same as that of the elongate fastener 24, even though the thread spacing is the same. This, or other differences between the two engaging threaded surfaces, can be used to increase resistance and improve any locking or securing function. In some embodiments, the secure fastener 22 can be described as a “self-locking” fastener. The terms “secure” and “self-locking” are broad terms and mean, without limitation, likely to resist unwanted loosening.

In FIG. 5A, the thread locking area 56 is illustrated at one end of the secure fastener 22. This can have the advantage of allowing an elongate fastener 24 to screw most of the way in before encountering the additional gripping or “locking” forces of the thread locking area 56. However, in some embodiments, a thread locking area with similar gripping properties can be located at a different place along the bore 30. For example, resilient material can be configured to contact an elongate fastener at intervals along the bore 30. In some embodiments, the material of the outer portion 44 can extend into apertures in the inner core 46. In such embodiments, a portion of the threads of the inner core 46 can be formed of the high tensile and shear force resistant composite and another portion of the threads can be formed of the more resilient composite. The threads formed of the more resilient polymer can extend further radially to the center of the secure fastener 22 than the threads formed of the high tensile and shear force resistant composite. When the threads of the elongate fastener 24, which can be sized to correspondingly fit the threads of the inner core 46 that are formed of the high tensile and shear force resistant composite, engage the threads formed of the more resilient composite, the threads formed of the resilient composite can be elastically deformed and exert an increased force on the elongate fastener 24. The increased force can provide resistance to turning either the elongate fastener 24 or the secure fastener 22 and improve the securing function of the fastener. Other configurations are also possible.

A method for making a secure composite fastener system 20 can include some or all of the following steps. The inner core 46 can be advantageously formed from a material blank of ECFG composite. The blank can be created by compression molding, injection molding, or extrusion, for example. After the ECFG material blank has cured, it can be machined in a way to orient the fibers so they extend radially into the threads, perpendicular to the shear force that may be applied by attempting to remove the elongate fastener. (see FIG. 5B). Finally, threads are tapped into the interior of the inner core 46. This arrangement of the fibers can help maximize the axial shear modulus of the threads of the inner core and improve the strength of the fastener system 20. The inner core 46 is then installed on a separate injection mold which contains a threaded mandrel. The threaded mandrel extends axially beyond the length of the inner core 46. PMFG is then molded around the inner core 46 and the threaded mandrel to form the outer portion 44, including the threaded portion of the outer portion, the head portion 26 and the base 28. The ECFG and PMFG materials chemically bond together as the PMFG cures. The threads of inner core 46 need not be machined but may also be formed directly in a mold.

In some embodiments, the outer portion 44 may be molded first in a mold containing a threaded mandrel. The newly molded outer portion 44 can then be placed in another mold, and the inner core 46 may then be molded within the outer portion 44.

Further information on composite fasteners, composite formulations, and methods of forming composites, and other related apparatus and methods can be found in U.S. Pat. No. 4,717,302, issued Jan. 5, 1998, titled COMPOSITE FASTENER; U.S. Pat. No. 4,778,637, issued Oct. 18, 1998, titled METHOD OF FORMING A COMPOSITE FASTENER, U.S. Pat. No. 5,129,148, issued Jul. 14, 1992, titled NON-METALLIC ROD END BEARING; U.S. Pat. No. 5,419,665, issued May 30, 1995, titled NON-METALLIC NUT RING. The entire contents of each of the above-mentioned patents are hereby incorporated by reference herein and are made a part of this specification.

The described methods can utilize various composite materials, including but not limited to all those materials described herein. Methods and processes described above may be embodied in, and fully automated via, software code modules executed by one or more general purpose computers. The code modules may be stored in any type of computer-readable medium or other computer storage device. Some or all of the methods may alternatively be embodied in specialized computer hardware. The collected user feedback data (e.g., accept/rejection actions and associated metadata) can be stored in any type of computer data repository, such as relational databases and/or flat files systems.

Reference throughout this specification to “some embodiments” or “an embodiment” means that a particular feature, structure or characteristic described in connection with the embodiment is included in at least some embodiments. Thus, appearances of the phrases “in some embodiments” or “in an embodiment” in various places throughout this specification are not necessarily all referring to the same embodiment. Furthermore, the particular features, structures or characteristics may be combined in any suitable manner, as would be apparent to one of ordinary skill in the art from this disclosure, in one or more embodiments.

In the above description of embodiments, various features of the inventions are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that any claim require more features than are expressly recited in that claim. Rather, inventive aspects lie in a combination of fewer than all features of any single foregoing disclosed embodiment.

Although the invention(s) presented herein have been disclosed in the context of certain preferred embodiments and examples, it will be understood by those skilled in the art that the invention(s) extend beyond the specifically disclosed embodiments to other alternative embodiments and/or uses of the invention(s) and obvious modifications and equivalents thereof. Thus, it is intended that the scope of the invention(s) herein disclosed should not be limited by the particular embodiments described above.

What is claimed is:

1. A system for fastening comprising:
a receiving fastener comprising:
an inner portion formed of a first polymeric composite material;
an outer portion formed of a second polymeric composite material, the first polymeric composite material having a shear modulus that is greater than that of the second polymeric composite material, and the second polymeric composite material having an elastic modulus that is greater than that of the first polymeric composite material; and
a threaded bore having an elongate axis that extends at least partially through both the first polymeric composite material of the inner portion and the second polymeric composite material of the outer portion, such that the bore has a first diameter through the inner portion and a second diameter through the outer portion, and the first diameter of bore is larger than the second diameter of the bore;
the inner portion of the receiving fastener extending only along a first partial length of the threaded bore and forming a sidewall of and immediately surrounding the threaded bore along that first partial length, the inner portion being arranged relatively inwardly of the outer portion with respect to the elongate axis of the threaded bore such that the inner portion is nested radially within the outer portion along the first partial length;
the outer portion of the receiving fastener extending the full length of the threaded bore but forming a sidewall of and immediately surrounding the threaded bore only long a second partial length of the threaded bore where the inner portion is not nested radially within the outer portion; and
a threaded elongate receivable fastener configured to be received by the receiving fastener and threadedly engage and extend through first the first partial length of the threaded bore, where the inner portion forms the sidewall of the bore, and as the elongate fastener is further inserted into the fastener, threadedly engage and extend through the second partial length of the threaded bore, where the outer portion forms the sidewall of the bore, such that the threaded elongate receivable fastener is fastened to the receiving fastener.

2. The system of claim 1, wherein the inner portion provides strength along the elongate axis of the inner bore to inhibit the receivable fastener from stripping out the threads of the receiving fastener.

3. The system of claim 1, wherein the outer portion provides a gripping force that inhibits relative rotation between the receivable and receiving fasteners.

4. The system of claim 1, wherein the material of the inner portion is chemically bonded to the material of the outer portion.

5. The system of claim 1, wherein the shear force resistant material of the inner portion is chemically bonded to the resilient material of the outer portion.

6. The system of claim 1, wherein the threads of the bore in the outer portion are more tightly spaced than the threads of the inner portion.

7. The system of claim 1, wherein the elongate fastener is a bolt.

8. The system of claim 1, wherein the fastener is configured as a nut having a head

9. The system of claim 8, wherein the head of the nut has a hexagonal shape configured to be received by a torque-applying tool.

10. An annular fastener comprising:
an inner portion configured to engage an elongate fastener, the inner portion comprising a shear force resistant material; and
an outer portion configured to engage both the inner portion and the elongate fastener, the outer portion comprising a material that is relatively more resilient than the shear force resistant material.

11. The annular fastener of claim 10, wherein the shear force resistant material comprises a composite of epoxy and chopped fiberglass.

12. The annular fastener of claim 10, wherein the material of the outer portion comprises a composite of polyetheretherketone and milled fiberglass.

13. The annular fastener of claim 10, wherein the elongate fastener is a bolt.

14. The annular fastener of claim 10, wherein the annular fastener is configured as a nut.

15. The annular fastener of claim 10, wherein the shear force resistant material of the inner portion is chemically bonded to the resilient material of the outer portion.

16. The annular fastener of claim 10, further comprising an inner bore that extends along a longitudinal axis of the annular fastener through the inner portion and the outer portion, the inner portion and the outer portion having threads along the length of the inner bore, wherein the threads are configured to non-permanently engage a threaded elongate fastener.

17. The annular fastener of claim 16, wherein the diameter of the bore in the outer portion is slightly decreased from the diameter in the inner portion.

18. The annular fastener of claim 16, wherein the threads of the bore in the outer portion are more tightly spaced than the threads of the inner portion.

19. The annular fastener of claim 16, wherein the threads of the bore in the outer portion have a different thread angle than the threads of the inner portion.

20. The annular fastener of claim 16, further comprising a thread locking portion at one end of the annular fastener.

21. The annular fastener of claim 16, further comprising thread locking portions spaced at intervals along the inner bore.

22. A secure fastener system comprising:
a two-part annular fastener comprising an inner portion and an outer portion, the inner portion comprising a shear-force resistant material, the outer portion comprising a material that is more resilient than the material of the shear-force resistant material, the material of the outer portion configured to engage the material of the inner portion; and
an elongate fastener.

23. The secure fastener system of claim 22, further comprising a threaded bore disposed in the central axis of the annular fastener and a threaded elongate fastener, the threaded bore configured to threadedly engage the threaded elongate fastener.

24. The secure fastener system of claim 22, wherein the two-part annular fastener is configured as a nut.

25. The secure fastener system of claim 22, wherein the elongate fastener is configured as a bolt.

26. The secure fastener system of claim 22, wherein the shear force resistant material comprises a composite of epoxy and chopped fiberglass.

27. The secure fastener system of claim 22, wherein the material of the outer portion comprises a composite of polyetheretherketone and milled fiberglass.

28. A method of fastening comprising:
inserting a threaded elongate fastener into a threaded annular fastener;
engaging threads of the elongate fastener with a sheer-force resistant portion of the threads in the annular fastener;
subsequently engaging threads of the elongate fastener with a resilient portion of the threads in the annular fastener;
reversibly deforming the resilient portion of the threads with the threads of the elongate fastener, causing the annular fastener to grip the elongate fastener.

29. A method of making a secure fastener comprising:
forming a threaded annular shaped inner core comprising a polymeric composite material having a high tensile modulus and shear modulus;
surrounding the inner core with an outer portion including a threaded surface, the outer portion comprising a composite material being more resilient than the material of the inner core.

30. The method of making a secure fastener of claim 29, wherein the step of forming comprises extruding and then machining the composite material.

31. The method of making a secure fastener of claim 29, wherein the step of surrounding comprises placing the inner core in an injection mold including threaded mandrel and injection molding the outer portion.

32. The method of making a secure fastener of claim 29, wherein the step of surrounding further comprises chemically bonding the outer portion to the inner core.
